(19) United States
(12) Patent Application Publication
(10) Pub. No.: US 2012/0198384 A1
(43) Pub. Date: Aug. 2, 2012

(54) GRAPHICAL USER INTERFACE PRESENTING A UNIFIED VIEW OF A MAIN DOCUMENT IMAGE AND THUMBNAIL IMAGES

(75) Inventor: Danny KUMAMOTO, Garden Grove, CA (US)

(73) Assignee: KONICA MINOLTA LABORATORY U.S.A., INC., San Mateo, CA (US)

(21) Appl. No.: 13/016,702

(22) Filed: Jan. 28, 2011

(51) Int. Cl. G06F 3/048

(52) U.S. Cl. 715/786; 715/781

(57) ABSTRACT

A GUI layout for displaying a main document image and multiple thumbnail images in a more space-efficient manner. One unified pane displays both a selected page of the document in a main image area and multiple thumbnail images each corresponding to a document page. The thumbnails and the main image area do not overlap. In some embodiments, the thumbnails include multiple groups of thumbnails having different sizes. When a user selects a thumbnail image, the corresponding document page is displayed in the main image area. The pane is provided with functions that allow the user to integrate the page viewing and selection process and to customize the pane, such as: scrolling of the thumbnail images, moving the document content displayed in the main image area, changing the physical size of the main image area, changing the zoom size of the document content in the main image area, etc.

This application is related to commonly owned U.S. patent application Ser. No. ______, filed ______ (attorney docket number 75675.B377), now pending, which is herein incorporated by reference in its entirety.

### BACKGROUND OF THE INVENTION

1. Field of the Invention

This invention relates to a graphical user interface, and in particular, it relates to a graphical user interface for presenting a main document image and multiple thumbnail images.

2. Description of Related Art

In many computer applications, one or more documents are displayed in a graphical user interface (GUI) in such a way that a plurality of pages of a document are displayed as thumbnail images and one or more selected pages of the document are displayed as the main document image. The thumbnail images corresponding to the selected pages are often highlighted. A thumbnail is a smaller size, lower resolution image of the page. The main document image is substantially larger and has a higher resolution than the thumbnail images. For example, when the document contains text, the main document image typically displays the text in legible sizes, while the text in thumbnail images is often illegible. In addition, the applications typically allow the user to operate on the main document image (e.g., edit the content of the document), while the thumbnail images are typically displayed as non-editable images. The user can select a page of the document by clicking on a thumbnail image and have that page displayed as the main image.

In typical conventional GUIs with main document image and thumbnail images, an example of which is schematically illustrated in FIG. 1, the thumbnail images 11 are located in a thumbnail pane 12 (a pane is a portion of the window 10, often with its own navigation tools) and the main document image 13 is located in a main image pane 14, where the two panes are separate window areas each having a defined, albeit often adjustable, size. Often, all thumbnail images of the document cannot fit within the finite size of the thumbnail pane, and scroll bars are provided for the thumbnail pane to allow the user to scroll through the thumbnail images.

A GUI such as that shown in FIG. 1 provides the user with the ability to streamline the editing process. By using the thumbnail images as a visual reference, the user can quickly scroll through the thumbnail images of the entire document, locate a specific page among the thumbnails, open it in the main image pane, and then apply desired editing or other functions to that page.

### SUMMARY

The present invention provides an improved GUI for presenting both a main document image and a plurality of thumbnail images that substantially obviates one or more of the problems due to limitations and disadvantages of the related art.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method for displaying a document on a computer display device, which includes: (a) displaying a window having at least one pane; (b) displaying a plurality of pages of the document as a plurality of thumbnail images within the pane, each thumbnail image corresponding to a page of the document; (c) displaying a selected page of the document in a main image area within the same pane, wherein the thumbnail images and the main image area are non-overlapping with each other; and (d) in response to a user selection of one of the thumbnail images, selecting a new page of the document corresponding to the selected thumbnail image and displaying the newly selected page in the main image area.

In another aspect, the present invention provides a computer program product comprising a computer usable non-transitory medium (e.g. memory or storage device) having a computer readable program code embedded therein for controlling a data processing apparatus, the computer readable program code being configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a conventional GUI window including a thumbnail pane and a main document image pane.

FIG. 2 schematically illustrates a GUI window for displaying thumbnail images and a main document image in a unified pane according to a first embodiment of the present invention.

FIG. 2a schematically illustrates the GUI window of FIG. 2 after the main image area size has been changed.

FIG. 3 schematically illustrates a GUI window for displaying thumbnail images and a main document image in a unified pane according to second and third embodiments of the present invention.

FIG. 4 schematically illustrates a GUI window for displaying thumbnail images and a main document image in a unified pane according to fourth and fifth embodiments of the present invention.

FIG. 5 illustrates a computer system in which embodiments of the present invention may be implemented.

### DETAILED DESCRIPTION OF PREFERRED EMBODIMENTS

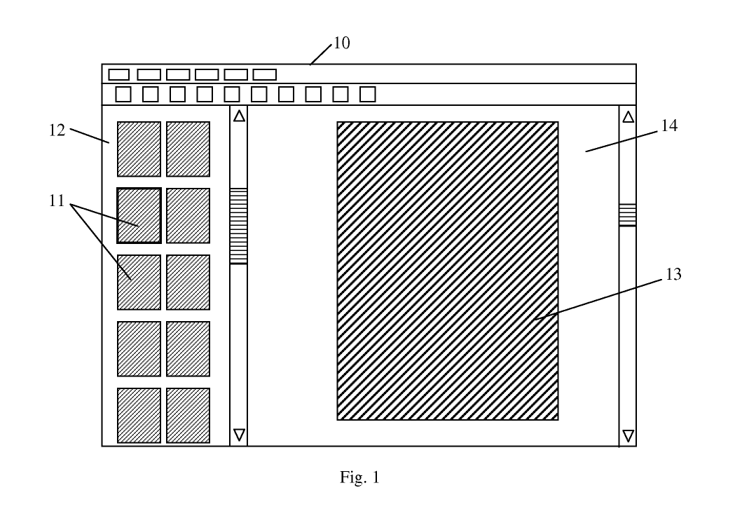

As pointed out earlier, a conventional GUI such as that shown in FIG. 1 requires two different panes to display the thumbnail images and the main document image. The thumbnail images are confined to the thumbnail pane, and the main document image is confined to the main image pane. This results in inefficient use of the screen real estate.

Embodiments of the present invention provide a layout of a GUI that displays both a main document image (one or more pages) and a plurality of thumbnail images in a more space-efficient manner. According to an embodiment of the present invention, one pane displays both the thumbnail images and the main document image. The thumbnail images and the main document image do not overlap and do not obscure each other. A pane is an area of a window, often with its own control tools; a window may consist of one pane, or it may be divided into multiple panes. This pane is provided with functions that allow the user to integrate the page viewing and selection process. The embodiment also allows the user to customize the pane as desired and as most efficient for the user's needs. Such a user interface display layout results in a more flexible display space for displaying a main image and a plurality of thumbnail images.

It should be noted here that the invention does not require the GUI window to have only one pane. In addition to the pane that displays the main document image and the thumbnail image, the window may have other panes for performing other functions. Also, while this disclosure refers to different areas of a window as panes, these areas can also be referred to as windows themselves. The term “pane” should be broadly understood to mean a defined area of the display screen where user content is displayed, and a pane may or may not have its own control tool such as menu items, buttons, and/or scroll bars.

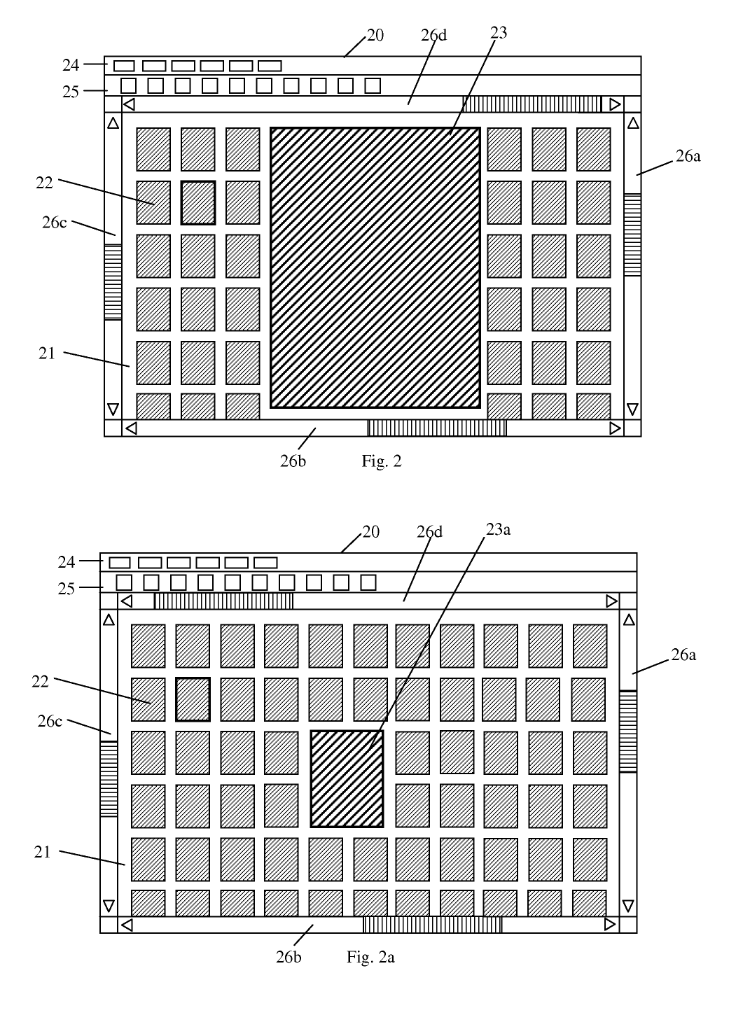

FIG. 2 schematically illustrates a user interface display window for displaying thumbnail images and a main document image in a unified pane according to a first embodiment of the present invention. As shown in FIG. 2, the GUI window 20 has a pane 21 which displays both a plurality of pages of a document as thumbnail images 22 and a selected page of the document in the main image area 23. The main image area and the thumbnail images do not overlap with each other. The user can select a thumbnail image and have the corresponding page displayed in the main image area, for example, by double clicking on the thumbnail. The main image area allows the user to edit the selected page or perform other desired functions with respect to the selected page.

The user may also navigate to different pages of the document by using a next page and a previous page button, by using arrow keys, by typing in a page number in a page number field, etc.

In the illustrated embodiment, the main image area 23 is located at or near a center of the pane 21 and the thumbnail images 22 are located to the left and right of the main document image. The main image area 23 may be highlighted, for example, by a frame or a halo of color around the image. The one thumbnail image that corresponds to the selected page is preferably also highlighted, for example, by a frame or a halo of the same color as the main image. The highlight of this thumbnail image helps the user to see the location of the selected page within the document and its relation with other pages of the document.

The window 20 may be provided with various control tools such as a menu bar 24 containing various menu items, a button bar 25 containing various functional buttons, scroll bars including right, bottom, left and top scroll bars 26a-d, etc. These control tools can be used by the user to effectuate various functions of the GUI window, as described below. The functions and their implementation described below are merely exemplary; not all of these functions are required, and other functions may be provided. The functions may be implemented using control tools other than those described below. Based on the description below, those skilled in the programming art will be able to implement these functions without undue experimentation.

Movement of the page content within the main image area. If the main image area 23 cannot display the content of the selected document page in its entirety, control tools may be provided to allow the user to move the display of the selected page within the main image area so that the desired content can be visible. The thumbnail images are not moved. In a preferred embodiment, these movement functions are implemented by the right and bottom scroll bars 26a and 26b to control the up/down and left/right movements of the display of the selected page, respectively. In addition, these scroll bars may also allow the user to scroll to the next page or previous page in the main image area.

Scrolling (moving) of thumbnail images in the pane. As shown in FIG. 2, the thumbnail images 22 are displayed in the areas of the pane 21 that are not taken by the main image area 23. The area of the pane 21 may not be sufficient to display thumbnail images of all pages of the document. In such a situation, a control tool may be provided to scroll the thumbnail images 22, i.e., to make the multiple thumbnail images physically move up and down or left and right within the pane 21 so that thumbnail images previously unseen can now be displayed. The main image area is not moved, nor is the content of the main image area changed. In a preferred embodiment, the thumbnails can only be scrolled in the up and down direction, and the left scroll bar 26c is used to scroll the thumbnail images 22 up and down. In an alternative embodiment, the thumbnail images may be scrolled in a left-right direction using the top scroll bar 26d.

Changing the physical size of the main image area. A control tool may be provided to allow the user to change the physical size of the main image area 23. In a preferred embodiment, this is accomplished using the top scroll bar 26d (if it is not used to scroll the thumbnails).

FIG. 2a schematically illustrates a GUI window which is the same as the GUI of FIG. 2 but in which the main image area 23a has a smaller size as compared to FIG. 2. As shown in FIG. 2a, after the main image area is changed to a smaller size, the display of the thumbnail images is rearranged (as compared to FIG. 2) so that thumbnail images fill in the space in the pane 21 which has been made available by the shrunken main image area. Likewise, if the main image area is changed from a smaller size to a larger size, the display of the thumbnail images is rearranged so that the thumbnail images do not overlap the main image area.

Using a smaller size for the main image area allows more thumbnail images to be displayed, making it easier for the user to see a large number of thumbnails at once and to quickly locate a desired page among the thumbnail images. In this example, the main image area 23a in FIG. 2a is approximately twice the linear size of the thumbnail images. While the size of the main image area 23 in FIG. 2 is sufficiently large to permit convenient editing operations on the selected page, the smaller size of the main image area 23a in FIG. 2a still allows the user to perform useful functions on the selected page, such as applying settings to the page.

Minimizing the main image area. A control tool may be provided to allow the user to minimize the main image area, i.e., to reduce the main image area to a small icon, so that substantially the entire pane can be used to display thumbnail images. This allows the user to see more thumbnail images at once, making it easier to navigate within the document and to locate a desired page. The minimizing function may be implemented using a popup menu associated with a mouse click such as a right mouse click, or a menu item in the menu bar 24, or a functional button in the button bar 25 may be used to implement the zoom function, or other means. The minimized main image area may be expanded to its original size using a menu item, button or popup menu. In addition, when the user clicks on a thumbnail image to select a page, the main image area is automatically expanded to its original size to display the selected page. After the main image area is minimized or expanded, the thumbnail images are automatically rearranged in the pane.

Changing the zoom size of the document content in the main image area. A control tool may be provided to change the zoom ratio of the content of the selected page of document being displayed in the main image area 23/23a. This zooming function is particularly useful when the main image area is set to a small size as in FIG. 2a, because it will allow the user to make the page content legible even when the physical size of the main image area is small. The zooming function may be implemented using a popup menu associated with a mouse click such as a right mouse click, or a menu item in the menu bar 24, or a functional button in the button bar 25 may be used to implement the zoom function, or other means.

Operations applicable to the thumbnails. Desired operations may be provided for the thumbnails, preferably whole page operations such as rotation of a page, cut and paste of a page, changing fonts of all the text in a given page, etc. In a preferred embodiment, these operations are implemented by a popup menu associated with a mouse click such as a right mouse click. The user may first select (e.g., by a mouse click) a target thumbnail image to be operated on. The user can also select multiple thumbnails (for example, using the CTRL plus mouse click operation or Apple-Key plus mouse click on MacOS) and perform batch operations on multiple pages.

The menu bar and button bar. The menu items in the menu bar 24 and the buttons in the button bar 25 of the GUI window 20 perform functions applicable to the main image area 23. For example, in a typical use case, the menu and buttons may implement various editing, formatting, and other functions for editing the content of the document page displayed in the main image area 23.

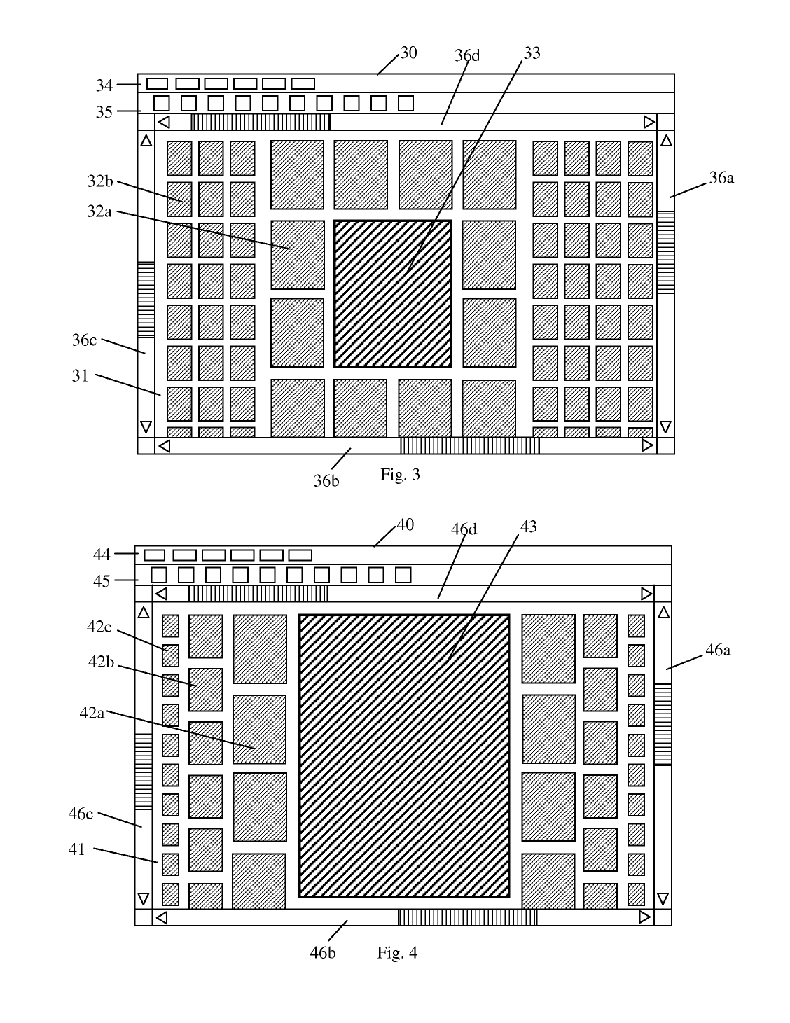

FIG. 3 schematically illustrates a GUI window for displaying thumbnail images and a main document image in a unified pane according to second embodiment of the present invention. As shown in FIG. 3, the GUI window 30 has a pane 31 which displays both a plurality of pages of a document as thumbnail images 32a and 32b, and a selected page of the document in a main image area 33. The main image area and the thumbnail images do not overlap with each other. The thumbnail images include two groups of thumbnail images, the thumbnail images in the first group 32a being larger in size than those in the second group 32b. The first (larger sized) group of thumbnail images 32a are physically located closer to the main image area 33; the second (smaller sized) group of thumbnail images 32b are physically located farther away from the main image area 33 and outside of the first group. The thumbnail images in the first group represent pages of the document adjacent to the selected page in the page order of the document; the thumbnail images in the second group represent pages of the document farther away from the selected page. In a preferred embodiment, a relatively small number of the larger thumbnail images 32a are displayed, while a relatively large number of the smaller thumbnail images 32b are displayed. The page that is displayed in the main image area is not displayed as a thumbnail.

For example, assume that the document has 100 pages and page #40 is displayed in the main image area 33. Pages #34-#39 and #41-#46 will be displayed as the larger thumbnails 32a; page #33 and a plurality of pages before it, and page #47 and a plurality of pages after it, will be displayed as the smaller thumbnails 32b; some pages will not be displayed due to insufficient space in the pane 31.

Similar to the first embodiment, the main image 33 allows the user to edit the page or perform other desired functions with respect to the page. Editing may also be allowed on thumbnails 32a in the first group. For example, the size of these thumbnails may be sufficiently large for the user to manipulate image or graphic objects on a page, even when the text on these thumbnails is not legible. In addition, other desired operations may be allowed for thumbnails in both groups, preferably whole page operations such as rotation of a page, cut and paste of a page, changing fonts of all the text in a given page, etc. The manner of performing these operations may be similar to that described in the first embodiment.

An advantage of this layout is that, having thumbnail images of two different sizes allows the user to edit or otherwise work on the selected page (main image), while being able to have a relatively large-sized thumbnail view of the preceding and following pages in the document, and at the same time being able to see more pages of the document via the smaller sized thumbnail images.

In this GUI display, when the user double clicks on a thumbnail image 32a/32b, either one within the first group or one within the second group, the corresponding page of the document is selected and displayed in the main image area 33, allowing the user to edit the page or perform other desired functions with respect to the selected page. The user may also navigate to different pages of the document using other tools such as a next page button, etc. as described in the first embodiment. When a new page is displayed in the main image area 33, all thumbnail images are redisplayed so that the first group (larger sized) of thumbnail images 32a now represent pages within the document that are closer to the newly selected page, and the second group (smaller sized) of thumbnail images represent pages farther away from the newly selected page.

One feature of the GUI display of the second embodiment is that the page order of the document is reflected in the spatial relationship between the main image 33 and the two groups of thumbnail images 32a/32b. In this embodiment, the thumbnail images 32a/32b are not allowed to scroll (move within the pane), so the visual correspondence between the page order and the locations of the pages in the GUI display is maintained. When a new page is displayed in the main image area, all images are updated and redisplayed in a coordinated manner.

Various functions may be implemented for the GUI window 30, similar to those described in the first embodiment. These functions may include movement of the page content within the main image area, changing the zoom size of the document content in the main image area, operations applicable to the thumbnails, etc. Further, a menu bar 34, a button bar 35, the scroll bars 36a-d, etc. may be provided to perform various functions of the GUI. Detailed descriptions are omitted here.

In a third embodiment of the present invention, a main image 33 and a first and a second group of thumbnail images 32a/32b are displayed as shown in FIG. 3, but the second group (smaller sized) thumbnails 32b can be scrolled (moved) within the pane 31 independently of the main image 33 and the first group of thumbnails 32a. When the second group of thumbnails are scrolled, e.g. moved collectively up and down, the main image 33 and the first group of thumbnails 32a remain unmoved and their content unchanged. This allows the user to see previously unseen pages via the thumbnails 32b, so that the thumbnails 32b can be used as a more effective navigation tool.

Further, in the third embodiment, the user is allowed to reduce the physical size of the main image area 33, or to minimize the main image area (i.e. reduce it to a small icon). When this occurs, the thumbnails 32a and 32b are redisplayed so that the space freed up by the main image area is now used to display more thumbnail images. Many variations may be implemented. For example, when the main image 33 is reduced to a smaller size, the size of the first group of thumbnail images 32a may be reduced accordingly. In another example, when the main image 33 is minimized, all thumbnail images are displayed in the smaller size so that more thumbnails are visible.

The second and third embodiments may be implemented as two different modes of the GUI layout shown in FIG. 3. The user may change between the two modes using a suitable tool such as a button in the button bar 35, and the behavior of the display will be different depending on the mode selected.

FIG. 4 schematically illustrates a GUI window for displaying thumbnail images and a main document image in a unified pane according to a fourth embodiment of the present invention. As shown in FIG. 4, the GUI window 40 has a pane 41 which displays both a plurality of pages of a document as thumbnail images 42a, 42b, 42c, etc., and a selected page of the document in a main image area 43. The main image area and the thumbnail images do not overlap with each other. The thumbnail images include multiple groups of thumbnail images 42a, 42b, 42c, etc. having successively smaller sizes, and correspond to pages of the document located successively farther away from the selected page in the page order of the document. In the illustrated example, three groups of thumbnail images correspond to three groups of pages. The first group of thumbnail images 42a have a larger size than the second group 42b, which in turn have a larger size than the third group 42c, etc. The first group of thumbnail images 42a are physically located immediately adjacent the main image area 43, the second group 42b are physically located farther away from the main image area 33 and outside of the first group, and the third group 42c are physically located even farther away and outside of the second group, etc. Preferably, the numbers of displayed thumbnails in the multiple groups are successively larger. The pages corresponding to the first group are located in the document adjacent the selected page, the pages corresponding to the second group are located farther away from the selected page than the first group, and the pages corresponding to the third group are located farther away from the selected page than the second group, etc. Each page of the document is displayed only once as either the main image or a thumbnail image (or not displayed due to insufficient space of the pane 41).

While the main image area 43 allows the user to edit the page or perform other desired functions with respect to the page, various functions may be allowed on various groups of thumbnails. For example, the largest group of thumbnails 42a may allow certain editing, and whole page operations may be allowed for all thumbnails, etc. The manner of performing these operations may be similar to that described in the earlier embodiments.

In this GUI, similar to the earlier embodiments, when the user double clicks on a thumbnail image 42a or 42b or 42c, the corresponding page of the document is selected and displayed in the main image area, allowing the user to edit the page or perform other desired functions with respect to the selected page. The user may also navigate to different pages of the document using other tools such as a next page button, etc. as described in earlier embodiments. When a new page is selected, the multiple groups of thumbnail images are redisplayed so that the groups of thumbnail images represent pages of the document located successively farther away from the newly selected page.

Similar to the second embodiment, one feature of the GUI display of the fourth embodiment is that the page order of the document is reflected in the spatial relationship of the main image 43 and the multiple groups of thumbnail images 42a-c. In this embodiment, the thumbnail images 42a-c are not allowed to scroll (move within the pane), so the visual correspondence between the page order and the locations of the pages in the GUI display is maintained. When a new page is displayed in the main image, all images are updated and redisplayed in a coordinated manner.

Various functions may be implemented for the GUI window 40, similar to those described in earlier embodiments. These functions may include movement of the page content within the main image area, changing the zoom size of the document content in the main image area, operations applicable to the thumbnails, etc. Further, a menu bar 44, a button bar 45, the scroll bars 36a-d, etc. may be provided to perform various functions of the GUI. Detailed descriptions are omitted here.

In a fifth embodiment of the present invention, a main image 43 and multiple groups of thumbnail images 42a-c are displayed as shown in FIG. 3, but some groups of the thumbnail image (e.g. the smallest sized group 42c) can be scrolled (moved) within the pane 41, while the main image 43 and the other group of thumbnails (e.g. 42a and 42b) remain unmoved and their content unchanged.

Further, in the fifth embodiment, the user is allowed to reduce the physical size of the main image area 43, or to minimize the main image area (i.e. reduce it to a small icon). When this occurs, the groups of thumbnails 42a-c are redisplayed so that the space freed up by the main image area is now used to display more thumbnail images. Many variations may be implemented. For example, when the main image 43 is reduced to a smaller size, the size of the first group of thumbnail images 42a may be reduced accordingly. In another example, when the main image 43 is minimized, all thumbnail images are displayed in the smallest size so that more thumbnails are visible.

The fourth and fifth embodiments may be implemented as two different modes of the GUI layout shown in FIG. 4. The user may change between the two modes using a suitable tool such as a button in the button bar 45, and the behavior of the display will be different depending on the mode selected.

In the embodiments shown in FIGS. 3 and 4, when a page near the beginning or end of the document is selected for display in the main image area, it is possible that there are fewer number of pages preceding or following the selected page than the number of pages that can be displayed in the space reserved for preceding or following pages. For example, in FIG. 4, if page 3 is displayed in the main image area 43, then the two preceding pages would not completely fill the area to the left of the main image area. In such a situation, there may be two different methods to handle the thumbnail image arrangement. In a first method, the unused thumbnail space would be left empty. In the above example, there will only be two thumbnail images to the left of the main image area 43 and the rest of the space will be empty. In a second method, the pages of the document are “wrapped” so that the last page and first page of the document are displayed adjacent to each other. In other words, the last page is treated as if it were the page before the first page, and the first page is treated as if it were the page after the last page, when the thumbnails are displayed. As a result, no empty space will be left in the pane. Optionally, a mark may be displayed to visually indicate the first and/or last page. For example, the mark may be a line between the thumbnails for the first and last pages.

In all of the above embodiments, if thumbnail images for all pages of the documents do not fit in the pane 21/31/41, special symbols such as ellipses, or thumbnail images containing special symbols such as ellipses, may be placed at appropriate locations such as near the upper left-hand or the lower right-hand corner of the pane to indicate that more pages exist but are not displayed.

In all of the above embodiments, the order of displaying the thumbnails according to page numbers may be left-to-right and then top-to-bottom, or top-to-bottom and then right-to-left, or other order as desirable and appropriate for different writing styles of different languages or culture. The treatment of the first and last pages may be appropriately adjusted in such instances.

Note that the GUIs in the first through fifth embodiments may have the same or similar menu bar, button bar and scroll bars, and only differ in the layout of the thumbnail images and the main image area. In an additional embodiment of the present invention, the GUI can display a plurality of thumbnail image and a main document image in a unified pane using any one of the layouts shown in FIGS. 2, 3 and 4, based on an option set by the user. The options may be presented to the user via a menu item in the menu bar, a functional button in the button bar, a popup menu, or other means. In other words, the various different layouts shown in FIGS. 2, 3 and 4 may be presented as different modes of the GUI display.

In all of the above embodiments, additional operations may be applied to the thumbnail images, depending on the particular application. One example is when the application program is a program for managing documents for printing. One function typically performed by such a program is to check for printer constraints, i.e., whether the printing requirements associated with the document match the printing capabilities of the printer that will be used to print it. When a mismatch is detected by the program, it may be desirable to automatically or semi-automatically change the printing requirements of the document to match the printing capabilities of the printed. For example, if the paper size specified for the document or some pages of the document is not supported by the printer, the paper size requirement may be changed (i.e. re-sized) so that it matches the paper size supported by the printer. In the GUI described in the above embodiments, a function may be implemented to assist the user in making changes in the printing requirements of the document. Further, an undo option may be implemented when making such changes. Specifically, when the user performs a printer constraint checking, the program will automatically determine the printing requirements that need to be changed (i.e. the auto-correction to be performed). In the GUI display, the thumbnail images will be marked to indicate the presence of auto-corrections, and the user is allowed to “accept” or “reject” the auto-correction for each page (or to “accept all” or “reject all” auto-corrections of the document).

In an alternative implementation of the auto-correction function (referred to as the auto corrected view mode), the GUI will only display thumbnail images of pages that have any auto-correction present. In other words, this is a filtering mechanism for viewing only the auto-corrected page. More broadly, other filters may be implemented to display selected pages as thumbnail images. For example, one filter may be to show only pages that have been edited as thumbnail images (edited-only view mode), so that the user can review all changes before saving. Another filter may be to show only pages that have not been edited as thumbnail images (non-edited view mode), so that the user can view all unchanged pages to ensure no changes are required on those pages.

It should be noted that the manner of performing automatic or semi-automatic changes to the document described above can be implemented in a conventional GUI display such as that shown in FIG. 1.

In the above described embodiments, various window control tools such as a menu bar containing various menu items, a button bar containing various functional buttons, multiple scroll bars, popup menu, etc. are used for controlling various aspects of the thumbnail and main image display of the GUI. It should be noted, however, the control tools that may be used to implement the various functions of the embodiments are not limited to those specifically described in this disclosure. More generally, any suitable window control tools may be used to implement the desired functions.

In the above described embodiments, a multi-page document is used as an example for the GUI display, where the main image and the thumbnail images each correspond to a page of the document. The embodiments of the invention may also be used in the environment of a folder containing multiple files, such as documents, photos, videos and the like, where the main image and the thumbnail images each correspond to one file. In lieu of the document page order, another order may be used to determine the location of each thumbnail image relative to the main image. For example, the order may be based on filename, date last modified, etc. The operations that may be performed on the main image and thumbnail images will depend on the nature of the files. For example, if the files are photos, the operation may include red-eye reduction, re-orientation (landscape vs. portrait), etc.

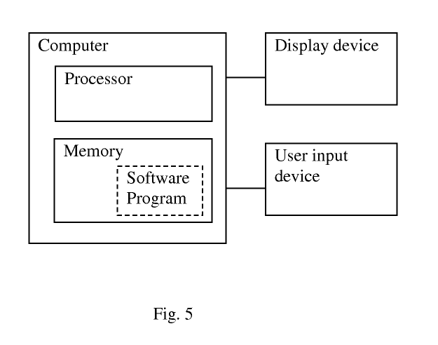

The user interface display methods described above can be implemented in a computer system which includes a processor and a memory storing a software program executed by the processor (see FIG. 5). The computer system also includes a display device for displaying the GUI window, as well as a user input device such as a keyboard and mouse for the user to input commands to the computer system. In one aspect, the invention is a method carried out by a computer system. In another aspect, the invention is computer program product embodied in computer usable non-transitory medium having a computer readable program code embedded therein for controlling a computer system.

It will be apparent to those skilled in the art that various modification and variations can be made in the user interface display and related method of the present invention without departing from the spirit or scope of the invention. Thus, it is intended that the present invention cover modifications and variations that come within the scope of the appended claims and their equivalents.

What is claimed is:

1. A method for displaying a document on a computer display device, comprising:
(a) displaying a window having at least one pane;
(b) displaying a plurality of pages of the document as a plurality of thumbnail images within the pane, each thumbnail image corresponding to a page of the document;
(c) displaying a selected page of the document in a main image area within the same pane, wherein the thumbnail images and the main image area are non-overlapping with each other; and
(d) in response to a user selection of one of the thumbnail images, selecting a new page of the document corresponding to the selected thumbnail image and displaying the newly selected page in the main image area.

2. The method of claim 1, wherein the main image area is located near a center of the pane and the thumbnail images are located on both sides of the main image area,
wherein one of the plurality of thumbnail images corresponding to the selected page is highlighted, and
wherein the main image area allows the user to edit or perform predefined functions with respect to the selected page of the document.

3. The method of claim 1, wherein the window includes a first control tool for moving content of the selected page of the document within the main image area without moving the thumbnail images.

4. The method of claim 1, wherein the window includes a second control tool for scrolling the thumbnail images within the pane without moving the main image area or changing the content displayed in the main image area.

5. The method of claim 1, wherein the window includes a third control tool for changing a size of the main image area, and wherein after the size of the main image area is changed, the thumbnail images are rearranged in the pane.

6. The method of claim 1, wherein the window includes a fourth control tool for reducing the main image area to an icon, and wherein after the main image area is reduced to the icon, the thumbnail images are rearranged in the pane.

7. The method of claim 1, wherein the window includes a fifth control tool for changing a zoom size of a content of the selected page displayed in the main image area.

8. The method of claim 1, wherein the plurality of thumbnail images include a first group of thumbnail images corresponding to a first plurality of pages of the document and a second group of thumbnail images corresponding to a second plurality of pages of the document, the thumbnail images of the first group having a larger size and physically located closer to the main image area than the thumbnail images of the second group, the first plurality of pages being closer to the selected page according to a page order of the document than the second plurality of pages.

9. The method of claim 8, wherein step (d) further includes redisplaying the first and second groups of thumbnail images based on the page order and the newly selected page.

10. The method of claim 8, wherein the window includes a sixth control tool for scrolling the second group of thumbnail images within the pane without scrolling the first group of thumbnail images and without moving the main image area or changing the content displayed in the main image area.

11. The method of claim 1, wherein the plurality of thumbnail images include a plurality of groups of thumbnail images corresponding to a plurality of groups of pages of the document, respectively, the thumbnail images of the plurality of group having successively smaller sizes and being physically located successively farther away from the main image area, the plurality of groups of pages of the document being successively farther away from the selected page according to a page order of the document.

12. The method of claim 11, wherein step (d) further includes redisplaying the plurality of groups of thumbnail images based on the page order and the newly selected page.

13. The method of claim 1, further comprising:
selecting one or more thumbnail images; and
applying an operation to the selected one or more thumbnail images.

14. A computer program product comprising a computer usable non-transitory medium having a computer readable program code embedded therein for controlling a computer system, the computer readable program code being configured to cause the computer system to execute a process for displaying a document on a display device of the computer system, the process comprising:
(a) displaying a window having at least one pane;
(b) displaying a plurality of pages of the document as a plurality of thumbnail images within the pane, each thumbnail image corresponding to a page of the document;
(c) displaying a selected page of the document in a main image area within the same pane, wherein the thumbnail images and the main image area are non-overlapping with each other; and
(d) in response to a user selection of one of the thumbnail images, selecting a new page of the document corresponding to the selected thumbnail image and displaying the newly selected page in the main image area.

15. The computer program product of claim 14, wherein the main image area is located near a center of the pane and the thumbnail images are located on both sides of the main image area,
wherein one of the plurality of thumbnail images corresponding to the selected page is highlighted, and
wherein the main image area allows the user to edit or perform predefined functions with respect to the selected page of the document.

16. The computer program product of claim 14, wherein the window includes a first control tool for moving content of the selected page of the document within the main image area without moving the thumbnail images.

17. The computer program product of claim 14, wherein the window includes a second control tool for scrolling the thumbnail images within the pane without moving the main image area or changing the content displayed in the main image area.

18. The computer program product of claim 14, wherein the window includes a third control tool for changing a size of the main image area, and wherein after the size of the main image area is changed, the thumbnail images are rearranged in the pane.

19. The computer program product of claim 14, wherein the window includes a fourth control tool for reducing the main image area to an icon, and wherein after the main image area is reduced to the icon, the thumbnail images are rearranged in the pane.

20. The computer program product of claim 14, wherein the window includes a fifth control tool for changing a zoom size of a content of the selected page displayed in the main image area.

21. The computer program product of claim 14, wherein the plurality of thumbnail images include a first group of thumbnail images corresponding to a first plurality of pages of the document and a second group of thumbnail images corresponding to a second plurality of pages of the document, the thumbnail images of the first group having a larger size and physically located closer to the main image area than the thumbnail images of the second group, the first plurality of pages being closer to the selected page according to a page order of the document than the second plurality of pages.

22. The computer program product of claim 21, wherein step (d) further includes redisplaying the first and second groups of thumbnail images based on the page order and the newly selected page.

23. The computer program product of claim 21, wherein the window includes a sixth control tool for scrolling the second group of thumbnail images within the pane without scrolling the first group of thumbnail images and without moving the main image area or changing the content displayed in the main image area.

24. The computer program product of claim 14, wherein the plurality of thumbnail images include a plurality of groups of thumbnail images corresponding to a plurality of groups of pages of the document, respectively, the thumbnail images of the plurality of group having successively smaller sizes and being physically located successively farther away from the main image area, the plurality of groups of pages of the document being successively farther away from the selected page according to a page order of the document.

25. The computer program product of claim 24, wherein step (d) further includes redisplaying the plurality of groups of thumbnail images based on the page order and the newly selected page.

26. The computer program product of claim 14, further comprising:
selecting one or more thumbnail images; and
applying an operation to the selected one or more thumbnail images.
